(19) United States
(12) Patent Application Publication
(10) Pub. No.: US 2016/0187550 A1
(43) Pub. Date: Jun. 30, 2016

(54) POLARIZING PLATE

(71) Applicant: NITTO DENKO CORPORATION, Osaka (JP)

(72) Inventors: Shusaku Goto, Ibaraki-shi (JP); Minoru Miyatake, Ibaraki-shi (JP)

(73) Assignee: NITTO DENKO CORPORATION, Osaka (JP)

(21) Appl. No.: 14/972,663

(22) Filed: Dec. 17, 2015

(30) Foreign Application Priority Data
Dec. 24, 2014 (JP) 2014-260264

(51) Int. Cl. G02B 5/30; G02B 1/14

(52) U.S. Cl. CPC G02B 5/305; G02B 1/14

(57) ABSTRACT

A polarizing plate according to an embodiment of the present invention includes a laminate produced by laminating a resin substrate having a percentage of water absorption of 0.2% or more and 3.0% or less and a glass transition temperature of 60° C. or more on one side of a polyvinyl alcohol-based film having a thickness of 30 μm or less, the laminate being subjected to dyeing treatment and stretching treatment including at least in-boric-acid-solution stretching. The polyvinyl alcohol-based film serves as a polarizing film and the resin substrate serves as a protective film for the polarizing film.

This application claims priority under 35 U.S.C. Section 119 to Japanese Patent Application No. 2014-260264 filed on Dec. 24, 2014, which are herein incorporated by references.

### BACKGROUND OF THE INVENTION

1. Field of the Invention

The present invention relates to a polarizing plate.

2. Description of the Related Art

A polarizing plate including a polarizing film is used in an image display apparatus, such as a liquid crystal display apparatus. As a method of producing the polarizing film, there is proposed a method involving forming a polyvinyl alcohol-based resin layer on a resin substrate by a coating method, and stretching and dyeing the laminate (for example, Japanese Patent Application Laid-open No. 2000-338329). According to such method, a polarizing film having a small thickness can be obtained, and hence the method has been attracting attention for its capability to contribute to the thinning of the image display apparatus. However, when the resin substrate is used, there is a problem in that restrictions are liable to be placed on a production process and the quality (for example, external appearance, polarization characteristic, or stretchability) of a polarizing film to be obtained is liable to be insufficient. There is also a problem in terms of cost.

### SUMMARY OF THE INVENTION

The present invention has been made in order to solve the conventional problems, and a primary object of the present invention is to provide a polarizing plate which is excellent in quality, and is also excellent in terms of production efficiency and cost.

According to one aspect of the present invention, a polarizing plate is provided. The polarizing plate includes a laminate produced by laminating a resin substrate having a percentage of water absorption of 0.2% or more and 3.0% or less and a glass transition temperature of 60° C. or more on one side of a polyvinyl alcohol-based film having a thickness of 30 μm or less, the laminate being subjected to dyeing treatment and stretching treatment including at least in-boric-acid-solution stretching. The polyvinyl alcohol-based film serves as a polarizing film and the resin substrate serves as a protective film for the polarizing film.

In one embodiment of the present invention, a constituent material for the resin substrate includes a polyethylene terephthalate-based resin.

In another embodiment of the present invention, the polyvinyl alcohol-based film and the resin substrate are laminated through intermediation of a water-based adhesive.

In still another embodiment of the present invention, the water-based adhesive includes a polyvinyl alcohol-based resin.

In still another embodiment of the present invention, the polyvinyl alcohol-based resin contains an acetoacetyl group.

In still another embodiment of the present invention, the polarizing film has a thickness of 10 μm or less.

In still another embodiment of the present invention, the protective film has a haze of 1% or less.

In still another embodiment of the present invention, the protective film has a crystallinity of 15% or more.

In still another embodiment of the present invention, the stretching treatment includes in-air stretching and in-boric-acid-solution stretching.

In still another embodiment of the present invention, the polarizing plate is produced by subjecting the resin substrate to crystallization treatment after the stretching treatment.

In still another embodiment of the present invention, the crystallization treatment is performed with a heat roll.

In still another embodiment of the present invention, the heat roll has a temperature of 80° C. or more.

In still another embodiment of the present invention, a polyvinyl alcohol-based resin constituting the polyvinyl alcohol-based film has a saponification degree of 99.0 mol % or more.

According to the embodiments of the present invention, a laminate is produced by laminating a resin substrate on one side of a polyvinyl alcohol-based film, and hence the resin substrate can be selected without consideration of the formation of a polyvinyl alcohol-based resin layer as described above. As a result, a polarizing film excellent in polarization characteristic can be produced by using a resin substrate suitable for treatment for producing a polarizing film (e.g., underwater stretching). Further, the resin substrate has no deformation associated with the formation of a polyvinyl alcohol-based resin layer, and hence a laminate excellent in surface uniformity can be produced. Such laminate can be subjected to various treatments to produce a polarizing film excellent in external appearance. The use of a resin substrate which satisfies a particular percentage of water absorption and a glass transition temperature can produce a polarizing plate excellent in durability. Specifically, the laminate is subjected to various treatments and the obtained resin substrate of the laminate can be used as a protective film without being peeled from the polarizing film. As a result, a polarizing plate can be produced at low cost.

### BRIEF DESCRIPTION OF THE DRAWINGS

FIG. 1 is a schematic cross-sectional view of a polarizing plate according to one embodiment of the present invention.

FIG. 2 is a schematic view for illustrating one example of crystallization treatment.

### DETAILED DESCRIPTION OF THE PREFERRED EMBODIMENTS

Embodiments of the present invention are described below. However, the present invention is not limited to these embodiments.

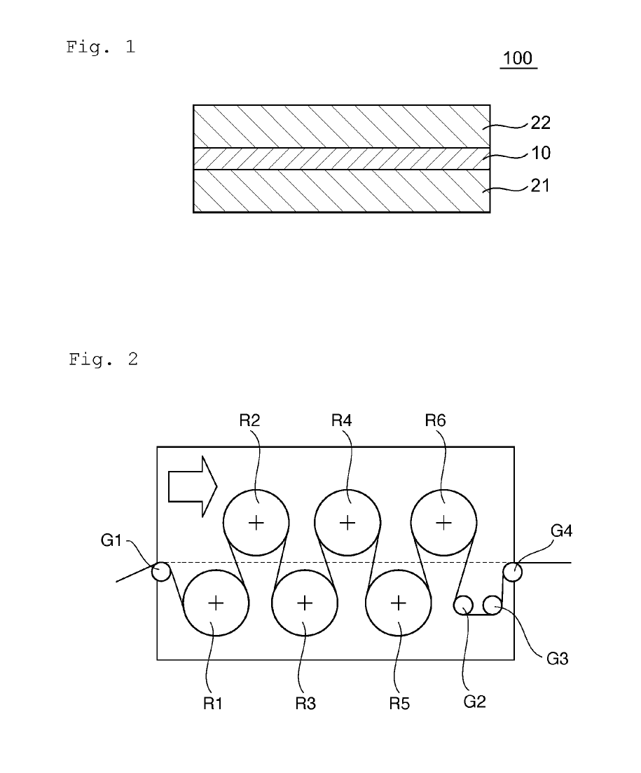

FIG. 1 is a schematic cross-sectional view of a polarizing plate according to one embodiment of the present invention. A polarizing plate 100 includes a polarizing film 10, a first protective film 21 arranged on one side of the polarizing film 10, and a second protective film 22 arranged on the other side of the polarizing film 10.

The polarizing film is substantially a polyvinyl alcohol (hereinafter sometimes referred to as “PVA”)-based resin film having a dichromatic substance adsorbed and aligned thereon. The polarizing film has a thickness of preferably 10 μm or less, more preferably 8 μm or less, more preferably 7 μm or less, particularly preferably 5 μm or less. On the other hand, the thickness of the polarizing film is preferably 1.0 μm or more, more preferably 2.0 μm or more.

The polarizing film preferably exhibits absorption dichroism at any wavelength in the wavelength range of from 380 nm to 780 nm. The polarizing film has a single axis transmittance of preferably 40.0% or more, more preferably 42.0% or more, still more preferably 42.5% or more, particularly preferably 43.0% or more. The polarizing film has a polarization degree of preferably 99.8% or more, more preferably 99.9% or more, still more preferably 99.95% or more.

The polarizing plate is obtained by subjecting a laminate obtained by laminating a resin substrate on one side of a polyvinyl alcohol-based film to dyeing treatment and stretching treatment.

Any appropriate resin may be adopted as a PVA-based resin constituting the PVA-based film. Examples of the resin include polyvinyl alcohol and an ethylene-vinyl alcohol copolymer. The polyvinyl alcohol is obtained by saponifying polyvinyl acetate. The ethylene-vinyl alcohol copolymer is obtained by saponifying an ethylene-vinyl acetate copolymer. The saponification degree of the PVA-based resin is typically from 85 mol % to 100 mol %, preferably 95.0 mol % or more, more preferably 99.0 mol % or more, particularly preferably 99.93 mol % or more. The saponification degree may be determined in conformity with JIS K 6726-1994. The use of the PVA-based resin having such saponification degree can provide a polarizing film excellent in durability.

The average polymerization degree of the PVA-based resin may be appropriately selected depending on purposes. The average polymerization degree is typically from 1,000 to 10,000, preferably from 1,200 to 6,000, more preferably from 2,000 to 5,000. It should be noted that the average polymerization degree may be determined in conformity with JIS K 6726-1994.

The thickness of the PVA-based film is preferably 30 μm or less, more preferably 25 μm or less, particularly preferably 20 μm or less. Meanwhile, the thickness of the PVA-based film is preferably 3 μm or more, more preferably 5 μm or more. This is because problems such as rupture in stretching can be prevented.

Any appropriate material may be adopted as a constituent material for the resin substrate. Examples of the material include an ester-based resin, such as a polyethylene terephthalate-based resin, a cycloolefin-based resin, an olefin-based resin, such as polypropylene, a (meth)acrylic resin, a polyamide-based resin, a polycarbonate-based resin, and a copolymer resin thereof. Of those, a polyethylene terephthalate-based resin is preferably used. In particular, an amorphous polyethylene terephthalate-based resin is preferably used. Specific examples of the amorphous polyethylene terephthalate-based resin include: a copolymer further containing isophthalic acid as a dicarboxylic acid; and a copolymer further containing cyclohexanedimethanol as a glycol.

The glass transition temperature (Tg) of the resin substrate is preferably 60° C. or more. When such resin substrate is used, a polarizing plate excellent in durability can be obtained. Meanwhile, the glass transition temperature of the resin substrate is preferably 100° C. or less, more preferably 80° C. or less. When such resin substrate is used, in the stretching of a laminate to be described later, stretchability (particularly in underwater stretching) can be sufficiently secured while the crystallization of the PVA-based film is suppressed. As a result, a polarizing film having an excellent polarization characteristic can be produced. It should be noted that the glass transition temperature (Tg) is a value determined in conformity with JIS K 7121.

The resin substrate has a percentage of water absorption of preferably 3.0% or less, more preferably 1.0% or less. When such resin substrate is used, a polarizing plate excellent in durability can be obtained. In addition, problems can be prevented such as deteriorated external appearance of a polarizing film to be obtained due to a significant reduction in dimension stability of the resin substrate at the time of production. Further, problems can be prevented such as the rupture of the resin substrate at the time of underwater stretching or the peeling of the PVA-based film from the resin substrate. Meanwhile, the resin substrate has a percentage of water absorption of preferably 0.2% or more, more preferably 0.3% or more. Such resin substrate absorbs water and the absorbed water can exhibit a plasticizer-like action to plasticize the resin substrate. As a result, a stretching stress is significantly decreased, and hence the resin substrate can be excellent in stretchability. It should be noted that the percentage of water absorption is a value determined in conformity with JIS K 7209.

The thickness of the resin substrate is preferably from 20 μm to 300 μm, more preferably from 50 μm to 200 μm. A surface of the resin substrate may be subjected to surface modification treatment (e.g., corona treatment), or may have an easy-adhesion layer formed thereon. Such treatments enable the production of a laminate excellent in adhesiveness between the resin substrate and the PVA-based film.

The laminate is obtained by laminating the resin substrate on one side of the PVA-based film. The laminate is preferably obtained by laminating the PVA-based film and the resin substrate through intermediation of an adhesive layer. Any appropriate adhesive is used as an adhesive for forming the adhesive layer. Specifically, the adhesive may be a water-based adhesive, or may be a solvent-based adhesive. A water-based adhesive is preferably used.

Any appropriate water-based adhesive may be adopted as the water-based adhesive. A water-based adhesive including a PVA-based resin is preferably used. The average polymerization degree of the PVA-based resin included in the water-based adhesive is preferably from about 100 to about 5,000, more preferably from 1,000 to 4,000 from the viewpoint of an adhesion property. The average saponification degree is preferably from about 85 mol % to about 100 mol %, more preferably from 90 mol % to 100 mol % from the viewpoint of an adhesion property.

The PVA-based resin included in the water-based adhesive preferably contains an acetoacetyl group. This is because a polarizing plate extremely excellent in adhesiveness between a polarizing film and a protective film and in durability can be obtained. An acetoacetyl group-containing PVA-based resin is obtained, for example, by subjecting a PVA-based resin and diketene to a reaction by any appropriate method. The acetoacetyl group modification degree of the acetoacetyl group-containing PVA-based resin is typically 0.1 mol % or more, preferably from about 0.1 mol % to about 40 mol %, more preferably from 1 mol % to 20 mol %, particularly preferably from 2 mol % to 7 mol %. It should be noted that the acetoacetyl group modification degree is a value measured by NMR.

The resin concentration of the water-based adhesive is preferably from 0.1 wt % to 15 wt %, more preferably from 0.5 wt % to 10 wt %.

In one embodiment, an adhesive is applied onto a surface of a resin substrate to bond a PVA-based film. The thickness of the adhesive at the time of the application may be set to any appropriate value. For example, the thickness is set so as to produce an adhesive layer having a desired thickness after heating (drying). A heating temperature is from 50° C. to 120° C., for example. A heating time is from 3 minutes to 10 minutes, for example. The thickness of an adhesive layer to be obtained is preferably from 10 nm to 300 nm, more preferably from 10 nm to 200 nm, particularly preferably from 20 nm to 150 nm.

An adhesive strength between the PVA-based film and the resin substrate is preferably 0.5 N/15 mm or more, more preferably 1.0 N/15 mm or more. When the adhesive strength falls within such range, a polarizing plate extremely excellent in adhesiveness between a polarizing film and a protective film can be obtained. Meanwhile, the adhesive strength between the PVA-based film and the resin substrate is preferably 10 N/15 mm or less. It should be noted that the adhesive strength is determined so that one end portion of the lengthwise direction of a test piece of 15 mm in width and 100 mm in length is peeled in advance, the peeled portion is held and peeled at a speed of 3 m/min in a 90° direction, and a tension at the time of the peeling is measured.

The shape of the laminate may correspond to the shape of the PVA-based film. For example, in the case where the PVA-based film has an elongate shape, the shape of the laminate is elongate. In this case, the PVA-based film and the resin substrate are preferably laminated so that their longitudinal directions are aligned. In one embodiment, in a laminate having an elongate shape, the width of the resin substrate is set larger than that of the PVA-based film. In this case, the resin substrate is preferably laminated so that the resin substrate protrudes toward the outside of both widthwise directions of the PVA-based film. The width of the laminate may be set to any appropriate value. The width is typically 500 mm or more and 5,000 mm or less, preferably 2,000 mm or more and 4,000 mm or less.

(Dyeing Treatment)

The dyeing treatment is typically performed by dyeing the PVA-based film with a dichromatic substance. The dyeing treatment is preferably performed by causing the PVA-based film to adsorb a dichromatic substance. A method for the adsorption is, for example, a method involving immersing the PVA-based film (laminate) in a dyeing liquid containing a dichromatic substance, a method involving applying the dyeing liquid onto the PVA-based film, or a method involving spraying the dyeing liquid on the PVA-based film. Of those, a method involving immersing the laminate in the dyeing liquid is preferred. This is because the film can satisfactorily adsorb the dichromatic substance.

Examples of the dichromatic substance include iodine and an organic dye. The substances may be used alone or in combination. Iodine is preferred as the dichromatic substance. When iodine is used as the dichromatic substance, the dyeing liquid is preferably an aqueous solution of iodine. The compounding amount of iodine is preferably from 0.1 part by weight to 0.5 part by weight with respect to 100 parts by weight of water. The aqueous solution of iodine is preferably compounded with an iodide in order to increase the solubility of iodine in water. Examples of the iodide include potassium iodide, lithium iodide, sodium iodide, zinc iodide, aluminum iodide, lead iodide, copper iodide, barium iodide, calcium iodide, tin iodide, and titanium iodide. Of those, potassium iodide is preferred. The compounding amount of the iodide is preferably from 0.02 part by weight to 20 parts by weight, more preferably from 0.1 part by weight to 10 parts by weight with respect to 100 parts by weight of water.

The liquid temperature of the dyeing liquid at the time of the dyeing is preferably from 20° C. to 50° C. in order to suppress the dissolution of the PVA-based film. When the PVA-based film is immersed in the dyeing liquid, an immersion time is preferably from 5 seconds to 5 minutes in order to secure the transmittance of the PVA-based film. In addition, the dyeing conditions (the concentration, the liquid temperature, and the immersion time) may be set so that the polarization degree or single axis transmittance of the polarizing film to be finally obtained may fall within a predetermined range. In one embodiment, the immersion time is set so that the polarization degree of the polarizing film to be obtained may be 99.98% or more. In another embodiment, the immersion time is set so that the single axis transmittance of the polarizing film to be obtained may be from 40% to 44%.

(Stretching Treatment)

Any appropriate method may be adopted as a method of stretching the laminate. Specifically, fixed-end stretching (e.g., a method involving using a tenter stretching machine) may be adopted, or free-end stretching (e.g., a method involving passing the laminate between rolls having different peripheral speeds to uniaxially stretch the laminate) may be adopted. Alternatively, simultaneous biaxial stretching (e.g., a method involving using a simultaneous biaxial stretching machine) may be adopted, or sequential biaxial stretching may be adopted. The stretching of the laminate may be performed in one stage, or may be performed in a plurality of stages. When the stretching is performed in a plurality of stages, the stretching ratio (maximum stretching ratio) of the laminate to be described later is the product of stretching ratios in the respective stages.

The stretching treatment may be an underwater stretching mode, in which stretching is performed while the laminate is immersed in a stretching bath, or may be an in-air stretching mode. It is preferred that underwater stretching treatment be performed at least once, and it is more preferred that underwater stretching treatment and in-air stretching treatment be performed in combination. According to the underwater stretching, the stretching can be performed at a temperature lower than the glass transition temperature (typically about 80° C.) of each of the resin substrate and the PVA-based film, and hence the PVA-based film can be stretched at a high ratio while its crystallization is suppressed. As a result, a polarizing film having an excellent polarization characteristic can be produced. In addition, the underwater stretching can improve the orientation property of the resin substrate (for example, polyethylene terephthalate-based resin substrate). When the resin substrate is brought into a high orientation state, the resin substrate can be crystallized in a short time in heating treatment such as crystallization treatment to be described later. In addition, a haze to be described later can be satisfactorily satisfied.

Any appropriate direction may be selected as a direction in which the laminate is stretched. In one embodiment, the laminate having an elongate shape is stretched in its longitudinal direction. Specifically, the laminate is conveyed in its longitudinal direction, and is stretched in its conveying direction (MD). In another embodiment, the laminate having an elongate shape is stretched in its width direction. Specifically, the laminate is conveyed in its longitudinal direction, and is stretched in a direction (TD) perpendicular to its conveying direction (MD).

The stretching temperature of the laminate may be set to any appropriate value depending on, for example, a formation material for the resin substrate and the stretching mode. When the in-air stretching mode is adopted, the stretching temperature is preferably equal to or higher than the glass transition temperature (Tg) of the resin substrate, more preferably Tg+10° C. or more, particularly preferably Tg+15° C. or more. Meanwhile, the stretching temperature of the laminate is preferably 170° C. or less. The stretching at such temperature suppresses rapid progress of the crystallization of the PVA-based resin, thereby enabling the suppression of a problem due to the crystallization (such as the inhibition of the orientation of the PVA-based film by the stretching).

When the underwater stretching mode is adopted as a stretching mode, the liquid temperature of a stretching bath is preferably from 40° C. to 85° C., more preferably from 50° C. to 85° C., particularly preferably from 60° C. to 75° C. At such temperature, the PVA-based film can be stretched at a high ratio while its dissolution is suppressed. Specifically, as described above, the glass transition temperature (Tg) of the resin substrate is preferably 60° C. or more. In this case, when the stretching temperature falls short of 40° C., there is a risk in that the stretching cannot be satisfactorily performed even in consideration of the plasticization of the resin substrate by water. On the other hand, as the temperature of the stretching bath increases, the solubility of the PVA-based film increases and hence an excellent polarization characteristic may not be obtained.

When the underwater stretching mode is adopted, the laminate is preferably stretched while being immersed in an aqueous solution of boric acid (in-boric-acid-solution stretching). The use of the aqueous solution of boric acid as the stretching bath can impart, to the PVA-based film, rigidity enough to withstand a tension to be applied at the time of the stretching and such water resistance that the film does not dissolve in water. Specifically, boric acid can produce a tetrahydroxyborate anion in the aqueous solution to cross-link with the PVA-based resin through a hydrogen bond. As a result, the PVA-based film can be satisfactorily stretched with the aid of the rigidity and the water resistance imparted thereto, and hence a polarizing film having an excellent polarization characteristic can be produced.

The aqueous solution of boric acid is preferably obtained by dissolving boric acid and/or a borate in water as a solvent. The concentration of boric acid is preferably from 1 part by weight to 10 parts by weight with respect to 100 parts by weight of water. Setting the concentration of boric acid to 1 part by weight or more can effectively suppress the dissolution of the PVA-based film, thereby enabling the production of a polarizing film having additionally high characteristics. It should be noted that an aqueous solution obtained by dissolving a boron compound, such as borax, glyoxal, glutaric aldehyde, or the like as well as boric acid or the borate in the solvent may also be used.

The stretching bath (aqueous solution of boric acid) is preferably compounded with an iodide. Compounding the bath with the iodide can suppress the elution of iodine that the PVA-based film has been caused to adsorb. Specific examples of the iodide are as described above. The concentration of the iodide is preferably from 0.05 part by weight to 15 parts by weight, more preferably from 0.5 part by weight to 8 parts by weight with respect to 100 parts by weight of water.

The laminate is preferably immersed in the stretching bath for a time of from 15 seconds to 5 minutes.

The stretching ratio (maximum stretching ratio) of the laminate is preferably 5.0 times or more with respect to the original length of the laminate. Such high stretching ratio can be achieved by adopting, for example, the underwater stretching mode (in-boric-acid-solution stretching). It should be noted that the term “maximum stretching ratio” as used herein refers to a stretching ratio immediately before the rupture of the laminate. The stretching ratio at which the laminate ruptures is separately identified and a value lower than the value by 0.2 is the maximum stretching ratio.

The underwater stretching treatment is preferably performed after the dyeing treatment.

As treatments for producing a polarizing film using the PVA-based film, there are given, for example, swelling treatment, cross-linking treatment, washing treatment, and drying treatment, in addition to those described above. Those treatments may be appropriately selected depending on purposes. In addition, the order, timing, number of times, and the like of the treatments may be appropriately set. The respective treatments are described below.

(Swelling Treatment)

The swelling treatment is typically performed by immersing the PVA-based film in water. Through the swelling treatment, uneven dyeing can be prevented, for example. The liquid temperature of a swelling bath is preferably from 20° C. to 40° C. The swelling treatment is preferably performed before the dyeing treatment.

(Cross-Linking Treatment)

The cross-linking treatment is typically performed by immersing the PVA-based film in an aqueous solution of boric acid. Water resistance can be imparted to the PVA-based film by subjecting the film to the cross-linking treatment. The concentration of the aqueous solution of boric acid is preferably from 1 part by weight to 4 parts by weight with respect to 100 parts by weight of water. In addition, when the cross-linking treatment is performed after the dyeing treatment, the solution is preferably further compounded with an iodide. Compounding the solution with the iodide can suppress the elution of iodine that the PVA-based film has been caused to adsorb. The compounding amount of the iodide is preferably from 1 part by weight to 5 parts by weight with respect to 100 parts by weight of water. Specific examples of the iodide are as described above. The liquid temperature of a cross-linking bath (the aqueous solution of boric acid) is preferably from 20° C. to 50° C. The cross-linking treatment is preferably performed before the underwater stretching treatment. In a preferred embodiment, the dyeing treatment, the cross-linking treatment, and the underwater stretching treatment are performed in the stated order.

(Washing Treatment)

The washing treatment is typically performed by immersing the PVA-based film in an aqueous solution of potassium iodide.

(Drying Treatment)

The drying temperature in the drying treatment is preferably from 30° C. to 100° C.

The resin substrate is preferably subjected to crystallization treatment. A polarizing plate more excellent in durability can be produced through the crystallization treatment. The crystallization treatment is typically performed by heating the resin substrate. The heating includes heating through the drying treatment. The crystallization treatment is preferably performed after the stretching treatment. In one embodiment, conditions for the crystallization treatment are set within such a range that the haze of a first protective film to be described later is obtained.

FIG. 2 is a schematic view for illustrating one example of the crystallization treatment. In the illustrated example, conveying rolls R1 to R6 are continuously arranged so that a center angle θ corresponding to a contact surface between the laminate and each conveying roll is 180° or more. A guide roll G1 is arranged, followed by the conveying roll R1 on the upstream side, and guide rolls G2 to G4 are arranged, following the conveying roll R6 on the downstream side. The laminate conveyed by the guide roll G1 is dried while being conveyed by the conveying rolls R1 to R6 heated to a predetermined temperature, and is fed to a straight path through the guide rolls G2 to G4.

Drying conditions may be controlled by adjusting the temperature of the heat rolls, the number of the heat rolls, and a time of contact with the heat rolls, and the like. The temperature of the heat rolls is preferably 80° C. or more, more preferably 90° C. or more. Through the adjustment to such temperature, the crystallinity of the resin substrate can be satisfactorily increased to produce a polarizing plate extremely excellent in durability. In addition, curling can be satisfactorily suppressed. Meanwhile, the temperature of the heat rolls is preferably 140° C. or less, more preferably 120° C. or less. Through the adjustment to such temperature, problems can be prevented such as deteriorated optical characteristics of a polarizing plate to be obtained. It should be noted that the temperature of the heat rolls may be measured with a contact thermometer. In the illustrated example, six conveying rolls are arranged, but the number of the conveying rolls is not particularly limited. The number of the conveying rolls to be arranged is generally from 2 to 10, preferably from 4 to 8. A time of contact (total time of contact) of the laminate with the heat rolls is preferably from 1 second to 100 seconds, more preferably from 3 seconds to 30 seconds.

The heat rolls may be arranged in a heating furnace (for example, an oven) or may be arranged in a general production line (under a room temperature environment). The heat rolls are preferably arranged in a heating furnace including blowing means. When the drying with the heat rolls and drying with hot air are used in combination, a steep change in temperature between the heat rolls can be suppressed and shrinkage in a widthwise direction can be easily controlled. A hot air drying temperature is preferably from 30° C. to 100° C. A hot air drying time is preferably from 1 second to 300 seconds. A hot air flow rate is preferably from about 10 m/s to about 30 m/s. It should be noted that the flow rate is a flow rate in a heating furnace and may be measured with a mini-vane type digital anemometer.

Through the crystallization treatment, the crystallinity of the resin substrate is increased by preferably 2% or more, more preferably 5% or more.

The polarizing plate of the present invention may be produced by subjecting the laminate to the treatments described above. Specifically, the polyvinyl alcohol-based film serves as a polarizing film, and the resin substrate serves as a protective film (in the illustrated example, a first protective film 21). The thickness of the first protective film is preferably from 15 μm to 80 μm, more preferably from 20 μm to 50 μm.

The first protective film has a haze of preferably 1% or less. It should be noted that the haze is a value determined in conformity with JIS-K6714.

The first protective film has a crystallinity of preferably 15% or more, more preferably 20% or more. The crystallinity is calculated by measuring a quantity of heat of crystal formation and a quantity of heat of crystal fusion at a rate of temperature increase of 10° C./min using a DSC apparatus (manufactured by Seiko Instruments Inc., EXSTAR DSC6000), and dividing a difference between the quantity of heat of crystal fusion and the quantity of heat of crystal formation at the time of the measurement by a quantity of heat of fusion for a perfect crystal (in the case of PET: 140 J/g), for example.

The polarizing plate of the present invention may include a protective film (second protective film 22) arranged on the other side of the polarizing film as shown in the illustrated example. As materials for forming the second protective film, there are given, for example, a (meth)acrylic resin, a cellulose-based resin, such as diacetyl cellulose or triacetyl cellulose, a cycloolefin-based resin, an olefin-based resin, such as polypropylene, an ester-based resin, such as a polyethylene terephthalate-based resin, a polyamide-based resin, a polycarbonate-based resin, and copolymer resins thereof. The thickness of the second protective film is preferably from 10 μm to 100 μm.

The second protective film may be laminated on the polarizing film through intermediation of the adhesion layer or may be laminated in close contact with the polarizing film (not through intermediation of the adhesion layer). The adhesion layer is typically formed of an adhesive or a pressure-sensitive adhesive.

### EXAMPLES

Now, the present invention is specifically described by way of Examples. However, the present invention is not limited to Examples.

### Example 1

### Production of Laminate

A polyvinyl alcohol film having a thickness of 20 μm (polymerization degree: 2,400, saponification degree: 99.9 mol %) and a resin substrate are laminated on each other with an aqueous PVA-based resin solution (manufactured by The Nippon Synthetic Chemical Industry Co., Ltd., trade name: “GOHSEFIMER (trademark) Z-200”, resin concentration: 3 wt %) as an adhesive to produce a laminate. An amorphous polyethylene terephthalate (A-PET) film (manufactured by Mitsubishi Plastics, Inc., trade name: “NOVACLEAR”, Tg: 80° C., percentage of water absorption: 0.60%) having a thickness of 100 μm and having a corona-treated surface was used as a resin substrate.

(Production of Polarizing Plate)

The obtained laminate was immersed in a swelling bath (pure water) at a liquid temperature of 30° C. (swelling treatment).

Next, the laminate was immersed in a dyeing bath at a liquid temperature of 30° C. while an iodine concentration and an immersion time were adjusted so that a polarizing plate to be obtained had a predetermined transmittance. In this example, the laminate was immersed in an aqueous iodine solution obtained by compounding 100 parts by weight of water with 0.1 part by weight of iodine and 0.7 part by weight of potassium iodide for 60 seconds (dyeing treatment).

Next, the laminate was immersed in a cross-linking bath (an aqueous boric acid solution obtained by compounding 100 parts by weight of water with 3 parts by weight of potassium iodide and 3 parts by weight of boric acid) at a liquid temperature of 30° C. for 30 seconds (cross-linking treatment).

After that, the laminate was uniaxially stretched in its longitudinal direction at a stretching ratio of 5.5 times between rolls having different peripheral speeds while being immersed in an aqueous boric acid solution (an aqueous solution obtained by compounding 100 parts by weight of water with 4 parts by weight of boric acid and 5 parts by weight of potassium iodide) at a liquid temperature of 70° C. (underwater stretching treatment).

After that, the laminate was immersed in a washing bath (an aqueous solution obtained by compounding 100 parts by weight of water with 4 parts by weight of potassium iodide) at a liquid temperature of 30° C. (washing treatment).

After that, the laminate was subjected to heating treatment while being conveyed by a heat roll arranged in an oven set to 60° C. and heated to 90° C. At this time, the contact time of the film with the heat roll was about 10 seconds.

Subsequently, an aqueous PVA-based resin solution (manufactured by The Nippon Synthetic Chemical Industry Co., Ltd., trade name: “GOHSEFIMER (trademark) Z-200”, resin concentration: 3 wt %) was applied onto a polyvinyl alcohol film surface of the laminate, a triacetyl cellulose film (manufactured by Konica Minolta, Inc., trade name: “KC4UY”, thickness: 40 μm) was bonded thereto, and the whole was heated in an oven maintained at 60° C. for 5 minutes. Thus, a polarizing plate having the construction of TAC film/polarizing film (thickness: 8 μm)/PET film (thickness: 40 μm, crystallinity: 21%) was produced.

### Example 2

A polarizing plate was produced in the same manner as in Example 1 except that an amorphous isophthalic acid-copolymerized polyethylene terephthalate (IPA-copolymerized PET) film (Tg: 75° C., percentage of water absorption: 0.75%) having a thickness of 100 μm was used as a resin substrate in the production of a laminate.

### Example 3

### Production of Laminate

A polyvinyl alcohol film (polymerization degree: 4,300, saponification degree: 99.3 mol %) having a thickness of 20 μm and a resin substrate were laminated on each other with an aqueous PVA-based resin solution (manufactured by The Nippon Synthetic Chemical Industry Co., Ltd., trade name: “GOHSEFIMER” (trademark) Z-200”, resin concentration: 3 wt %) as an adhesive to produce a laminate. An amorphous isophthalic acid-copolymerized polyethylene terephthalate (IPA-copolymerized PET) film (Tg: 75° C., percentage of water absorption: 0.75%) having a thickness of 100 μm and having a corona-treated surface was used as a resin substrate.

(Production of Polarizing Plate)

The obtained laminate was subjected to free-end uniaxial stretching in its lengthwise direction (longitudinal direction) at 2.0 times between rolls having different peripheral speeds in an oven at 120° C. (in-air stretching).

Next, the obtained laminate was immersed in a swelling bath (pure water) at a liquid temperature of 30° C. (swelling treatment).

Next, the laminate was immersed in a dyeing bath at a liquid temperature of 30° C. while an iodine concentration and an immersion time were adjusted so that a polarizing plate to be obtained had a predetermined transmittance. In this example, the laminate was immersed in an aqueous iodine solution obtained by compounding 100 parts by weight of water with 0.1 part by weight of iodine and 0.7 part by weight of potassium iodide for 60 seconds (dyeing treatment).

Next, the laminate was immersed in a cross-linking bath (an aqueous boric acid solution obtained by compounding 100 parts by weight of water with 3 parts by weight of potassium iodide and 3 parts by weight of boric acid) at a liquid temperature of 30° C. for 30 seconds (cross-linking treatment).

After that, the laminate was uniaxially stretched in its longitudinal direction at a stretching ratio of 6.0 times between rolls having different peripheral speeds while being immersed in an aqueous boric acid solution (an aqueous solution obtained by compounding 100 parts by weight of water with 4 parts by weight of boric acid and 5 parts by weight of potassium iodide) at a liquid temperature of 70° C. (underwater stretching treatment).

After that, the laminate was subjected to heating treatment while being conveyed by a heat roll arranged in an oven set to 60° C. and heated to 90° C. At this time, the contact time of the film with the heat roll was about 10 seconds.

Subsequently, an aqueous PVA-based resin solution (manufactured by The Nippon Synthetic Chemical Industry Co., Ltd., trade name: “GOHSEFIMER (trademark) Z-200”, resin concentration: 3 wt %) was applied onto a polyvinyl alcohol film surface of the laminate, a triacetyl cellulose film (manufactured by Konica Minolta, Inc., trade name: “KC4UY”, thickness: 40 μm) was bonded thereto, and the whole was heated in an oven maintained at 60° C. for 5 minutes. Thus, a polarizing plate having the construction of TAC film/polarizing film (thickness: 8 μm)/PET film (thickness: 40 μm, crystallinity: 24%) was produced.

### Example 4

A polarizing plate was produced in the same manner as in Example 3 except that a polyvinyl alcohol film (polymerization degree: 2,400, saponification degree: 99.9 mol %) having a thickness of 25 μm was used in the production of a laminate.

### Example 5

A polarizing plate was produced in the same manner as in Example 3 except that an amorphous cyclohexanedimethanol-copolymerized polyethylene terephthalate (CHDM-PET) film (manufactured by Mitsubishi Plastics, Inc., trade name: “NOVACLEAR SH046”, Tg: 75° C., percentage of water absorption: 0.35%) having a thickness of 150 μm was used as a resin substrate in the production of a laminate.

### Comparative Example 1

A polarizing plate was produced in the same manner as in Example 1 except that an unstretched polypropylene film (manufactured by Tohcello Co., Ltd., RXC Series, Tg: −10° C., percentage of water absorption: 0.03%) having a thickness of 70 μm was used as a resin substrate in the production of a laminate.

### Comparative Example 2

A polarizing plate was produced in the same manner as in Example 1 except that a nylon 6 film (unstretched nylon film, manufactured by Mitsubishi Plastics, Inc., trade name: “DIAMIRON C”, Tg: 65° C., percentage of water absorption: 3.50%) having a thickness of 100 μm was used as a resin substrate in the production of a laminate.

### Comparative Example 3

A polarizing plate was attempted to be produced in the same manner as in Example 1 except that an unstretched polystyrene film (Tg: 80° C., percentage of water absorption: 0.03%) having a thickness of 100 μm was used as a resin substrate in the production of a laminate.

### Comparative Example 4

A polarizing plate was attempted to be produced by subjecting a polyvinyl alcohol film (polymerization degree: 2,400, saponification degree: 99.9 mol %) having a thickness of 20 μm to the same treatments as those in Example 1 without using a resin substrate.

### Comparative Example 5

A polarizing plate was attempted to be produced by subjecting a polyvinyl alcohol film (polymerization degree: 2,400, saponification degree: 99.9 mol %) having a thickness of 25 μm to the same treatments as those in Example 1 without using a resin substrate.

(Evaluation) The following evaluation was performed for each of Examples and Comparative Examples.

### 1. Stretchability

Whether or not a total stretching ratio of 5.0 times or more was attained by stretching including underwater stretching was confirmed.

### 2. Heat Durability

A pressure-sensitive adhesive was formed on a TAC film side of the obtained polarizing plate, and the resultant plate was cut into a size of 100 mm×100 mm to produce a sample piece. The sample piece was bonded onto a glass plate, and the resultant plate was placed in an oven at 85° C. for 120 hours. The polarizing plate was observed for its change in external appearance before and after in the oven.

In the case where the polarizing plate was deformed or had a peeled resin substrate, the durability was evaluated as “poor”.

### 3. Humidity Durability

A pressure-sensitive adhesive layer was formed on a TAC film side of the obtained polarizing plate, and the resultant plate was cut into a size of 100 mm×100 mm to produce a sample piece. The sample piece was bonded onto a glass plate, and the resultant plate was placed in an oven at 60° C. and a humidity of 95% humidity for 120 hours. The polarizing plate was observed for its change in external appearance before and after in the oven.

In the case where the polarizing plate was deformed or had a peeled resin substrate, the durability was evaluated as “poor”.

TABLE 1

| | | | Resin substrate | | | | | | |
|---|---|---|---|---|---|---|---|---|---|
| | | | | | Percentage | | | | |
| | | PVA film | | | of water | | | Heat | Humidity |
| | | Thickness | Material | Tg | absorption | Stretching | Stretchability | durability | durability |
| Example | 1 | 20 μm | A-PET | 80° C. | 0.60% | Underwater | Possible | Good | Good |
| | 2 | 20 μm | Modified | 75° C. | 0.75% | Underwater | Possible | Good | Good |
| | | | A-PET | | | | | | |
| | 3 | 20 μm | Modified | 75° C. | 0.75% | In-air + | Possible | Good | Good |
| | | | A-PET | | | underwater | | | |
| | 4 | 25 μm | Modified | 75° C. | 0.75% | In-air + | Possible | Good | Good |
| | | | A-PET | | | underwater | | | |
| | 5 | 20 μm | CHDM-PET | 75° C. | 0.35% | In-air + | Possible | Good | Good |
| | | | | | | underwater | | | |
| Comparative 3 | 1 | 20 μm | PP | −10° C. | 0.03% | Underwater | Possible | Poor | Poor |
| Example | 2 | 20 μm | Nylon 6 | 65° C. | 3.50% | Underwater | Possible | Good | Poor |
| | 3 | 20 μm | PS | 80° C. | 0.03% | Underwater | Impossible | — | — |
| | 4 | 20 μm | — | — | — | Underwater | Rupture | — | — |
| | 5 | 25 μm | — | — | — | Underwater | Rupture | — | — |

In each of Examples, by virtue of excellent stretchability of the PVA film, a polarizing plate excellent in polarization characteristic and excellent in durability can be produced at low cost. On the other hand, in Comparative Examples 1 and 2, the stretchability can be secured but the durability is insufficient. In Comparative Examples 3 to 5, the stretchability cannot be secured. Specifically, in Comparative Example 3, the laminate cannot be stretched under water, and in Comparative Examples 4 and 5, the PVA film ruptures at the time of underwater stretching.

The polarizing plate of the present invention is suitably used for an image display apparatus. Specifically, the polarizing plate of the present invention is suitably used for liquid crystal panels of, for example, liquid crystal televisions, liquid crystal displays, mobile phones, digital cameras, video cameras, portable game machines, car navigation systems, copying machines, printers, facsimile machines, timepieces, and microwave ovens, and anti-reflection plates of organic EL devices.

What is claimed is:

1. A polarizing plate, comprising:
a laminate produced by laminating a resin substrate having a percentage of water absorption of 0.2% or more and 3.0% or less and a glass transition temperature of 60° C. or more on one side of a polyvinyl alcohol-based film having a thickness of 30 μm or less,
the laminate being subjected to dyeing treatment and stretching treatment including at least in-boric-acid-solution stretching,
wherein the polyvinyl alcohol-based film serves as a polarizing film and the resin substrate serves as a protective film for the polarizing film.

2. The polarizing plate according to claim 1, wherein a constituent material for the resin substrate comprises a polyethylene terephthalate-based resin.

3. The polarizing plate according to claim 1, wherein the polyvinyl alcohol-based film and the resin substrate are laminated through intermediation of a water-based adhesive.

4. The polarizing plate according to claim 3, wherein the water-based adhesive comprises a polyvinyl alcohol-based resin.

5. The polarizing plate according to claim 4, wherein the polyvinyl alcohol-based resin contains an acetoacetyl group.

6. The polarizing plate according to claim 1, wherein the polarizing film has a thickness of 10 μm or less.

7. The polarizing plate according to claim 1, wherein the protective film has a haze of 1% or less.

8. The polarizing plate according to claim 1, wherein the protective film has a crystallinity of 15% or more.

9. The polarizing plate according to claim 1, wherein the stretching treatment comprises in-air stretching and in-boric-acid-solution stretching.

10. The polarizing plate according to claim 1, wherein the polarizing plate is produced by subjecting the resin substrate to crystallization treatment after the stretching treatment.

11. The polarizing plate according to claim 10, wherein the crystallization treatment is performed with a heat roll.

12. The polarizing plate according to claim 11, wherein the heat roll has a temperature of 80° C. or more.

13. The polarizing plate according to claim 1, wherein a polyvinyl alcohol-based resin constituting the polyvinyl alcohol-based film has a saponification degree of 99.0 mol % or more.
